(19) United States
(12) Patent Application Publication
(10) Pub. No.: US 2010/0263218 A1
(43) Pub. Date: Oct. 21, 2010

(54) KNIFE WITH BLADE SPINE SUPPORT AND MAGNETIC KNIFE MOUNTING BLOCK THEREFOR

(75) Inventor: Ryan Scott Bookhamer, Edinboro, PA (US)

Correspondence Address: BLYNN L. SHIDELER;THE BLK LAW GROUP, 3500 BROKKTREE ROAD, SUITE 200, WEXFORD, PA, 15090, US

(73) Assignee: INDUSTRIAL RD LC, TAMPA, FL (US)

(21) Appl. No.: 11/874,453

(22) Filed: Oct. 18, 2007

Related U.S. Application Data
(60) Provisional application No. 60/958,393, filed on Jul. 3, 2007.
(60) Provisional application No. 60/975,227, filed on Sep. 26, 2007.

(51) Int. Cl. B26B 3/00; B26B 29/00; B26B 9/02

(52) U.S. Cl. 30/298.4; 30/340; 30/342; 30/355; 206/372

(57) ABSTRACT

A knife includes a knife blade defining a knife plane having a cutting edge on one side and a spine an opposed side, wherein the cutting edge and the spine meet at a point of the knife blade at a distal end thereof, the knife blade including a bolster at an end of the knife blade opposed from the point and a tang adjacent the bolster, and a handle attached to the tang of the knife blade, the handle includes a body portion, the handle includes a spine support extending along a portion of the spine of the knife blade and coupled to the knife blade at a position spaced from the point, and wherein the spine support is spaced from the spine for at least a portion of the spine. A resilient buffer member may be provided between the knife blade and the handle.

### RELATED APPLICATIONS

This application claims priority to U.S. provisional patent application Ser. No. 60/958,393 filed Jul. 3, 2007, entitled “Handle system for cutting implements consisting of a base handle, blade, & support member, support member assists the blade by displacing pressure from the handle to the blade, through the support member, supporting the tip and ability to slide/change load point along the blade as load increases, stabilizing tip vertically, horizontally, and rotationally. The support member can be attached to handle and or blade. The member can pivot, and become adjustable” and U.S. provisional patent application Ser. No. 60/975,227 filed Sep. 26, 2007, entitled “Stand system consisting of base with open slots and magnets for the positioning of cutting utensils into the base. Magnets guide cutting utensil blade into the open slots for stable holding position of cutting utensils into base. Slots may be contoured to utensils blade shape for increased support. Slots and magnets hold blade & cutting utensil body in secure position. System can be applied to horizontal, side, and vertical base positions”

### BACKGROUND OF THE INVENTION

1. Field of the Invention

The present invention relates to knife design, to knife sets, and to a mounting block for the display of an associated knife set.

2. Background Information

There is simply no substitute for the knife. It is an incredible and ancient hand tool that has helped man survive, hunt and eat. It has evolved with man and although technology has leapfrogged ahead, the basic structure of the knife has remained the same. The basics of the knife construction include a planar blade with at least one sharp edge and a handle.

In prehistoric times, knives were made of flint. Flint was easily cut, scaled and sharpened. Flint could easily be re-sharpened as they became dull. Flint knives gradually developed into copper, bronze and iron knives. Most commercial knife blades today are made of steel, however, a few specialty knives are made with ceramic blades, such as zirconium carbide and zirconium oxide. The modern steel knife blades can in turn be divided into three broad groups: carbon steel, stainless steel, and high carbon stainless steel. Other composites, alloys and materials could, of course, be used to form a knife blade, but the above listed materials remain the most common for modern knife blade construction.

Defining the knife anatomy is helpful in understanding the construction of a knife. As described above a knife will have at least a handle and a knife blade. Other functional elements and ornamental features have been included in known knife constructions. Within the meaning of this application a knife blade is a planar member having a cutting edge along one edge and a blade spine along an opposed edge of the knife blade. The knife blade will generally be symmetrical about a longitudinal knife plane. The cutting edge can take many forms such as straight cutting edge, serrated cutting edge (e.g. a bread knife), and combinations thereof (e.g. a steak knife). The straight cutting edge can be formed in many ways, for example simple two converging straight sides, converging concave sides, or converging convex sides. The possible variations with a serrated cutting edge are even larger, as the saw tooth shape of the serrations adds further design possibilities.

The spine, sometimes called the back, is generally the thickest, heaviest length of the knife blade and supports the entire blade. The wider and thicker the spine, the stronger the blade along its length.

The knife blade begins at the point, which is generally where the spine and the cutting edge meet. The bolster is a thickened portion, i.e. thicker than the cutting edge, of the knife blade just before the handle, sometimes called the rear or butt of the knife blade. Bolsters can be considered as a feature of forged blades where the manufacturing process starts with a thicker piece of metal than when the blade is stamped. The bolster tends to extend all the way to the cutting edge and sharpening the cutting edge all the way to the end of the heel can be difficult with many standard methods of knife sharpening. Some chefs believe that the bolster gives a knife better balance. The bolster also helps prevent the user's hand from slipping onto the blade. There may further be a guard at the knife blade end of the handle that functions in a similar manner.

The cutting edge can be considered as being formed of three portions, the tip, the middle and the heel. The tip of the knife blade is generally the first third of the blade and extends from the point. The tip is generally used for puncturing tough materials, such as the skin on some vegetables, and is used for cutting very thin items. The most used part of a knife is the middle of the cutting edge and works best when the knife is moved with a forwards and backwards motion. The middle can be considered to be about the middle third of the knife blade. The best cut is achieved by moving the knife blade parallel to the cut. The heel is about the final third of the cutting edge near the handle. The heel is used mostly for heavy cutting, or when maximum leverage is needed. It is most efficient for making quick, coarse cuts, and for jobs which require strength or pressure.

The part of the blade that extends into the handle is called a tang. A “full” tang is one that extends all the way to the butt or distal end of the handle.

Knife handles come in both natural materials, such as wood, and in molded materials. Some modern knives are also being manufactured with hollow metal handles that are welded to the tang of the knife blade to give the appearance of the knife being made out of a single piece of metal. The knife handles will have a longitudinal plane that is generally co-incident with the plane of the knife blade. The handles will often be symmetrical about the handle longitudinal plane.

The common longitudinal plane of the handle and knife blade defines a tool orientation can distinguish the knife from some other common implements. For example, certain scraping tools have a blade, such as a razor blade, in a plane perpendicular to the longitudinal plane of the handle. A vegetable peeler is a common tool with a handle having a longitudinal plane perpendicular to the plane of the peeling blade.

The handle may have a guard at the end of the handle that is adjacent the knife blade. The handle has a body or grip portion that is designed to fit the user's hand, including finger receiving recesses and flats on either side. Conventionally the handle is designed such that several fingers of the user's hand wrap around the handle on the “cutting edge” side of the handle, with a portion for receiving the user's thumb or forefinger on the spine side of the handle. User's often place their fore finger directly on the spine of the knife blade in use in many knife configurations, and this requires the spine to be modified accordingly, such as rounding off the sides. There have been many ergonomic grip or body designs in order to improve knife design. The distal end of the handle is the butt of the handle.

The above definitions for the anatomy of a knife have not been universally applied, such as referencing the above defined point of the knife blade as the tip, or the rear (i.e. the bolster) of the knife blade as the back (or vise versa), or the bolster as the tang, and so on. The imprecision in common knife terminology likely stems from the extremely high common knowledge of the implement itself, whereby the selected concepts are still conveyed to readers without the same universal definition of the terms. Regardless, the above description is intended to allow for a more precise description of the knife of the present invention.

There remains a need in the art to provide a knife that provides the user with a good, “balanced” feel in operation. It is one object of the present invention to improve the interaction of the knife blade and the handle.

With the development of sets of knives came the development of mounting blocks to hold and to display them. Culinary knife sets, in particular, have resulted in the development of practical and ornamental knife mounting blocks. The knife mounting blocks typically consist of a base, often a wooden block, with a series of slots therein that receive the knife blade of an associated knife. The knives are sheathed within respective slots in the base, and once the tip is engaged within the slot the slot will guide the knife blade into the supported position. The exterior of the base member can take a number of shapes, essentially for ornamental appeal, as for culinary knife sets, it is almost customary for the knife mounting block to remain on display in the user's kitchen.

There remains a need in the art for knife mounting blocks that can hold a plurality of knifes of a knife set that is easy to use, does not damage the knives, and offers a wide variety of block configuration to the designer for aesthetic appeal. It is one object of the invention to provide an effective knife mounting block that offers new design opportunities to the designers of the base shape.

### SUMMARY OF THE INVENTION

In accordance with one aspect of the present invention a knife includes a knife blade defining a knife plane having a cutting edge on one side and a spine an opposed side, wherein the cutting edge and the spine meet at a point of the knife blade at a distal end thereof, the knife blade including a bolster at an end of the knife blade opposed from the point and a tang adjacent the bolster, and a handle attached to the tang of the knife blade, the handle includes a body portion, the handle includes a spine support extending along a portion of the spine of the knife blade and coupled to the knife blade at a position spaced from the point, and wherein the spine support is spaced from the spine for at least a portion of the spine. The spine support acts to effectively and efficiently transmit cutting force from the user's hand to the distal portions of the knife blade.

A resilient buffer member may be provided between the knife blade and the handle. A resilient buffer member may be provided between the knife blade and the spine support as well. The coupling between the spine support and the knife blade may allow for relative motion, such as pivoting there between. The spine support may be a curved or arcuate member designed to flex. The spine support may have a diverging cross section in a direction extending away from the knife blade. The spine support may be coupled to the knife blade at a location laterally aligned with the tip of the cutting edge of the knife blade.

One aspect of the present invention provides a knife including a knife blade defining a knife plane having a cutting edge on one side and a spine an opposed side of the knife blade, wherein the cutting edge and the spine meet at a point of the knife blade at a distal end of the knife blade, the knife blade including a bolster at an end of the knife blade opposed from the point and a tang adjacent the bolster, and a handle attached to the tang of the knife blade, further including a resilient buffer member between the tang of the knife blade and the handle, wherein the handle includes a body portion and the handle includes a spine support extending along a portion of the spine of the knife blade and coupled to the knife blade, and wherein the spine support is spaced from the spine for at least a portion of the spine.

One aspect of the present invention provides a culinary knife set comprising a plurality of knives, each knife of the knife set including a knife blade defining a knife plane having a cutting edge on one side and a spine an opposed side of the knife blade, wherein the cutting edge and the spine meet at a point of the knife blade at a distal end of the knife blade, the knife blade including a bolster at an end of the knife blade opposed from the point and a tang adjacent the bolster, and a handle attached to the tang of the knife blade, the handle includes a body portion, the handle includes a spine support extending along a portion of the spine of the knife blade and coupled to the knife blade at a position spaced from the point, and wherein the spine support is spaced from the spine for at least a portion of the spine.

A mounting block may be provided for selectively receiving the knives of the knife set, wherein the mounting block may include a body having knife receiving grooves on an upper surface thereof. The knife blades may be steel and the mounting block may further include magnetic members selectively engaging the knife blades within the grooves.

One aspect of the present invention provides a mounting block for selectively receiving the knives of a knife set, the mounting block comprising a body having knife receiving grooves on an upper surface thereof, wherein the grooves on the mounting block body are configured to extend from a point to a bolster end of each associated knife; and a plurality magnetic members selectively engaging the knife blades within the grooves.

One aspect of the present invention provides a cutting implement comprising a blade defining a blade plane having a cutting edge on one side and a spine an opposed side of the blade, the blade including a bolster at an end of the blade a tang adjacent the bolster; and a handle attached to the tang of the blade, the handle includes a body portion, the handle includes a spine support extending along a portion of the spine of the blade and coupled to the blade at a position spaced from the tang, wherein the spine support is spaced from the spine for at least a portion of the spine, wherein the coupling between the spine support and the blade allows a pivoting motion there between.

It is noted that, as used in this specification and the appended claims, the singular forms “a,” “an,” and “the” include plural referents unless expressly and unequivocally limited to one referent. The features that characterize the present invention are pointed out with particularity in the claims which are part of this disclosure. These and other features of the invention, its operating advantages and the specific objects obtained by its use will be more fully understood from the following detailed description and the operating examples.

These and other advantages are described in the brief description of the preferred embodiments in which like reference numeral represent like elements throughout.

### BRIEF DESCRIPTION OF THE FIGURES

FIG. 1 is a perspective view of a culinary knife set and mounting block in accordance with one embodiment of the present invention;

FIG. 2 is a schematic side elevation view of a knife in accordance with one embodiment of the present invention;

FIG. 3 is a top, front perspective view of the knife shown in FIG. 2;

FIG. 4 is a top plan view of the knife shown in FIG. 2;

FIG. 5 is a bottom plan view of the knife shown in FIG. 2;

FIG. 6 is a schematic side elevation view of a knife in accordance with another embodiment of the present invention;

FIG. 7 is a top, front perspective view of the knife shown in FIG. 6;

FIG. 8 is a schematic side elevation view of a knife in accordance with another embodiment of the present invention;

FIG. 9 is a schematic side elevation view of a knife in accordance with another embodiment of the present invention;

FIG. 10 is a schematic side elevation view of a knife in accordance with another embodiment of the present invention;

FIG. 11 is a schematic side elevation view of a knife in accordance with another embodiment of the present invention;

FIG. 12 is a schematic side elevation view of a knife in accordance with another embodiment of the present invention;

FIG. 13 is a schematic side elevation view of a hand saw in accordance with another embodiment of the present invention;

FIG. 14 A is a schematic side elevation view of a full tang knife blade in accordance with one embodiment of the present invention;

FIG. 14 B is a schematic side elevation view of a partial tang knife blade in accordance with another embodiment of the present invention;

FIG. 15 A is a schematic side elevation view of a full tang knife blade in accordance with one embodiment of the present invention;

FIG. 15 B is a schematic side elevation view of a partial tang knife blade in accordance with another embodiment of the present invention;

FIG. 16 is a schematic perspective view of a resilient buffer member for use with the partial tang knife blade of FIG. 15;

FIG. 17 is an enlarged schematic side elevation view of a knife blade and spine connection illustrating the relative motion there between in accordance with another embodiment of the present invention;

FIG. 18 is a schematic front view of the blade engaging end of a spine support of a handle of a knife in accordance with one embodiment of the present invention;

FIG. 19 is a schematic sectional view of a reinforced spine support of a handle of a knife in accordance with one embodiment of the present invention;

FIG. 20 is a schematic perspective view of the mounting block of FIG. 1;

FIG. 21 is a schematic top plan view of the mounting block of FIG. 20

FIG. 22 is a partially transparent perspective view of the mounting block of FIG. 20; and

FIG. 23 is a section view of the mounting block of FIG. 20.

### DESCRIPTION OF THE PREFERRED EMBODIMENTS

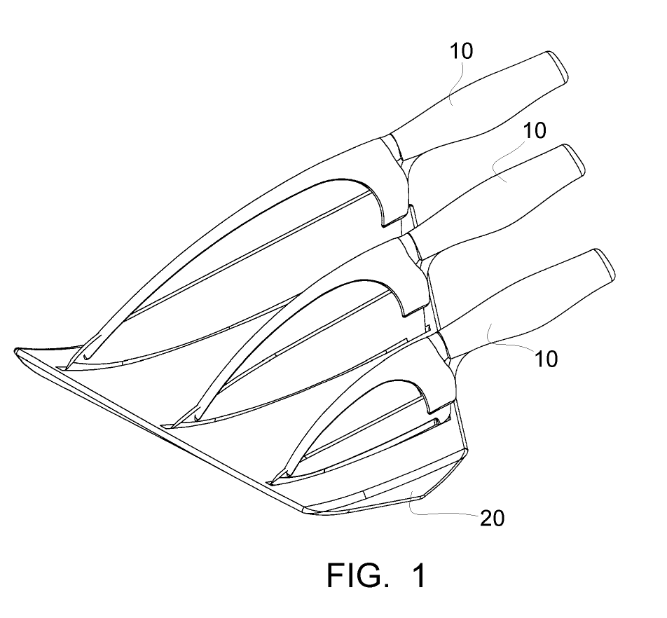

FIG. 1 is a perspective view of a culinary knife set formed of a plurality of knifes 10 and mounting block 20 in accordance with one embodiment of the present invention.

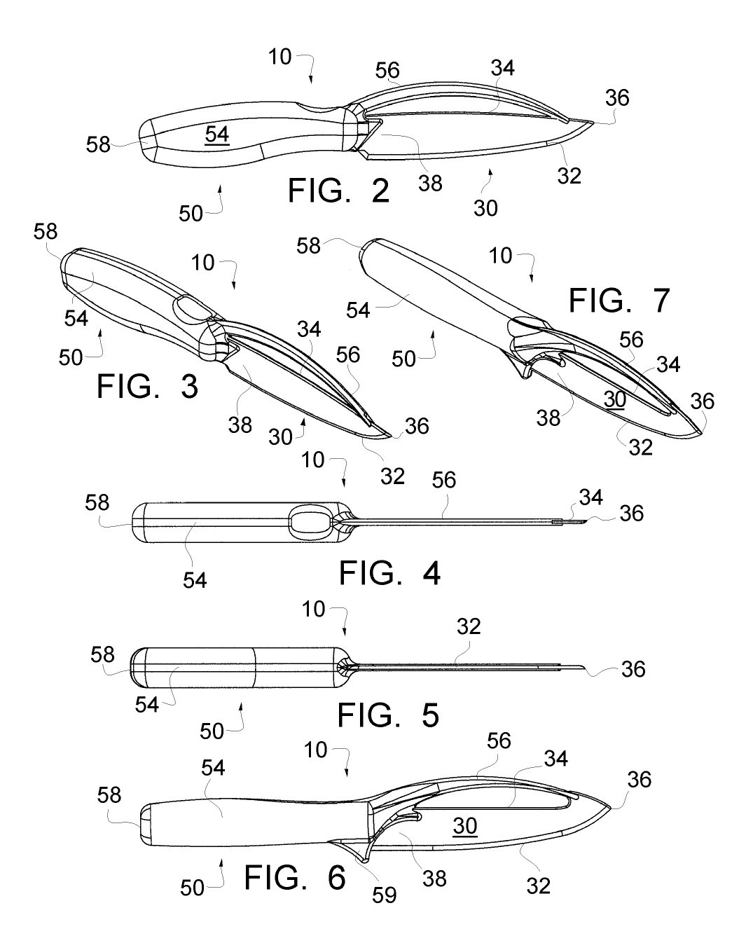

FIGS. 2-5 illustrate a knife 10 in accordance with one embodiment of the present invention. The knife 10 includes a knife blade 30 defining a knife plane having a cutting edge 32 on one side and a spine 34 an opposed side of the knife blade 30. The spine 34 will generally be the thickest part of the knife blade 30. The cutting edge 32 and the spine 34 meet at a point 36 of the knife blade 30 at a distal end of the knife 10.

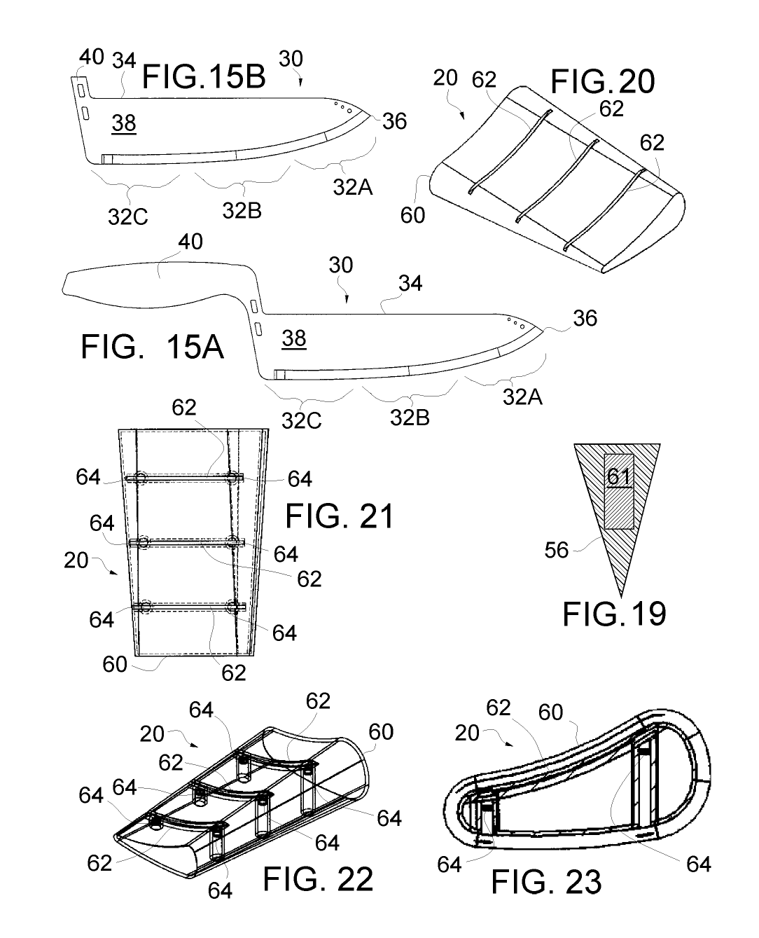

The knife blade 30 including a bolster 38 at an end of the knife blade 30 opposed from the point 36 and a tang 40 (see FIGS. 14a and b and 15a and b) adjacent the bolster 38. The bolster 38 will generally be the same thickness as the spine 34 and extend to the cutting edge 32. The tang 40 may be a full tang (i.e. one that extends the length of the handle) as shown in FIGS. 14a and 15a or a partial tang as shown in FIGS. 14b and 15b. The tang may be a vertical tang meaning that it extends above the spine 34 as shown in FIGS. 15 a and b. The tang 40 may further include mounting holes therethrough for receipt of fasteners, such as rivets, or other configurations to assist in mounting to the handle 50. For example the tang 40 may have a width and length and profile generally matching the associated handle 50. The thickness of the tang 40 can be varied as desired, but will often be the same thickness as the bolster 38.

The cutting edge 32, as discussed in the background, can take many forms such as straight cutting edge, serrated cutting edge (e.g. a bread knife), and combinations thereof (e.g. a steak knife). The straight cutting edge 32 can be formed in many ways, for example simple two converging straight sides, converging concave sides, or converging convex sides. The cutting edge 32 can be considered as being formed of three portions, the tip 32a, the middle 32b and the heel 32c as shown in FIGS. 14 and 15. The tip 32a of the knife blade 30 is effectively the first third of the knife blade 30 and extends from the point 36. The shape of the tip 32a will depend largely upon the intended purpose for the culinary knife 10. The most used part of a culinary knife 10 is the middle 32b of the cutting edge 32 and can be considered to be about the middle third of the knife blade 30. The heel 32c is about the final third of the cutting edge 32 near the bolster 38 and the handle 50 and is generally used mostly for heavy cutting and when maximum leverage is needed.

The knife blades 30 are made of steel, namely carbon steel, stainless steel, or high carbon stainless steel, or ceramic, such as zirconium carbide or zirconium oxide.

A handle 50 attached to the tang 40 of the knife blade which is received within the handle 50. The handle 50 has a groove or recess therein for the receipt of the tang 40. The handle 50 can be formed as two halves fastened on opposed sides of the tang 40. For a full tang 40 that is shaped identical to the handle 50, the tang receiving recess will extend the entire length of the handle 50. The handle 50 can be attached to the tang with mechanical fasteners, such as rivets, screws, or nuts and bolts; adhesives; welding, or combinations thereof as generally known in the art. There may be multiple connection points between the tang 40 and the handle 50.

One aspect of the present invention is to place a resilient buffer member 52 as shown in FIG. 16 between the tang 40 of the knife blade 30 and the handle 50. This member 52 can be a thin rubber member or other resilient material that can be utilized in the desired environment (e.g. will not become brittle over time and can undergo temperatures associated with dishwashing). The member 52 provides an isolation mount or shock absorber to the user to provide a better feel to the knife 10 in use. The member 52 can be useful in decreasing the breakage of the handle 50 such as when the knife is dropped. For a full tang 40 that is shaped identical to the handle 50, the member 52 can be formed as two rubber members on opposed sides of the tang 40. Where fasteners are used as a coupling mechanism, the member 52 can include resilient bushings surrounding the fasteners.

The handle includes a body or grip portion 54 that can be ergonomically shaped to receive the user's hand. The handle 50 further includes an arcuate or bow shaped spine support 56 extending along a portion of the spine 34 of the knife blade 30 and coupled to the knife blade 30 at a position spaced from the point 36. The spine support 56 is spaced from the spine 34 for a substantial portion of the spine 34 as shown.

The spine support 56 represents a key component of the present invention and provides a force transmission mechanism for the user to transfer some of the cutting force applied to the grip portion 54 of the handle 50 to the upper end of the knife blade 30 to provide a more even cutting force for increased control. Cutting force will also be applied through the gripping portion 54 to the tang 40 of the knife blade 30 in a conventional fashion as well. A resilient buffer member, such as a rubber element, can be used between the spine support 56 and the blade 30, if desired, but the member 52 described above will provide greater benefit to the knife 10 relative to minimizing breakage and shock absorption.

The spine support 56 is constructed to have some flex therein to provide a spring type action. It is preferable that the connection between the blade 30 and the spine support 56 accommodate this relative motion, such as shown in FIG. 17. The spine support 56 may be notched as shown in FIG. 18 to be received over the spine 34 of the blade 30. The blade 30 may also be notched as shown in FIGS. 14 and 15 to further receive and couple the spine support 56 thereto. A mechanical fastener may be used to couple the spine support 56 to the blade 30, but such attachment should accommodate the relative movement between the spine support and the blade 30. The relative movement may be a sliding movement of the spine support 56 along a longitudinal segment of the spine 34. Alternatively, such as where a locking notch or fastener holds the longitudinal position of the spine support 56 relative to the blade 30, the relative movement will be a pivoting movement as shown in FIG. 17.

The amount of movement between the spine support 56 and the blade 30 depends upon the construction of the spine support 56 and further upon the connection between the handle 50 and the tang 40 of the blade 30. A single fastener connection between the tang 40 and the handle 50 can allow for a greater degree of movement as the knife blade 30 could then have a small degree of pivot relative to the gripping portion 54. The spine support 56 can also accommodate the user's forefinger thereon to apply force directly to the tip 32a of the blade 30. This construction of the present invention is preferable to having the user's place a finger directly on the metal (or ceramic) spine 34 as is common in the use of prior art knifes, and often requires modifications to the blade spine of the prior art knifes (e.g. rounded edges of sufficient diameter to avoid injury to the user).

The handle 50 has a distal or butt end 58 adjacent the body portion 54 and may include a guard 59, as shown in the embodiments of FIGS. 6-7. The handle 50 will have a longitudinal plane that is generally co-incident with the plane of the knife blade 30 as shown in FIGS. 3 and 4. The handle 50 will often be symmetrical about the handle longitudinal plane. As noted above the handle 50 may be formed of two pieces, however in such a two piece construction the pieces need not be identical or mirror images of each other. It is anticipated that a simpler more sturdy construction in two piece handle 50 arrangements if the spine support 56 were formed entirely on one of the two pieces that are subsequently attached to opposed sides of the tang 40. The handle 50 can be made out of any convenient material such as wood, metal or plastic. Where plastic material is used, conventional manufacturing, such as by injection molding, can be utilized. A molded handle 50 typically will allow for the most ornamental shapes that can be formed in an economic manner.

FIGS. 6 and 7 illustrate a knife 10 in accordance with the present invention substantially as described above. The handle 50 includes a guard 59 as noted above. Further, the spine 34 of the blade 30 in this embodiment includes a spine extension extending up from the blade 30. This construction mainly affects the look of the knife 10, but does allow the spine support 56 coupling to the blade 30 to be away from the tip 32a and the associated cutting. Further the extension of the spine 34 can allow for slip fit notch connection between the spine support 56 and the blade 30 in a manner that minimizes unwanted decoupling of the elements in use without mechanical fasteners.

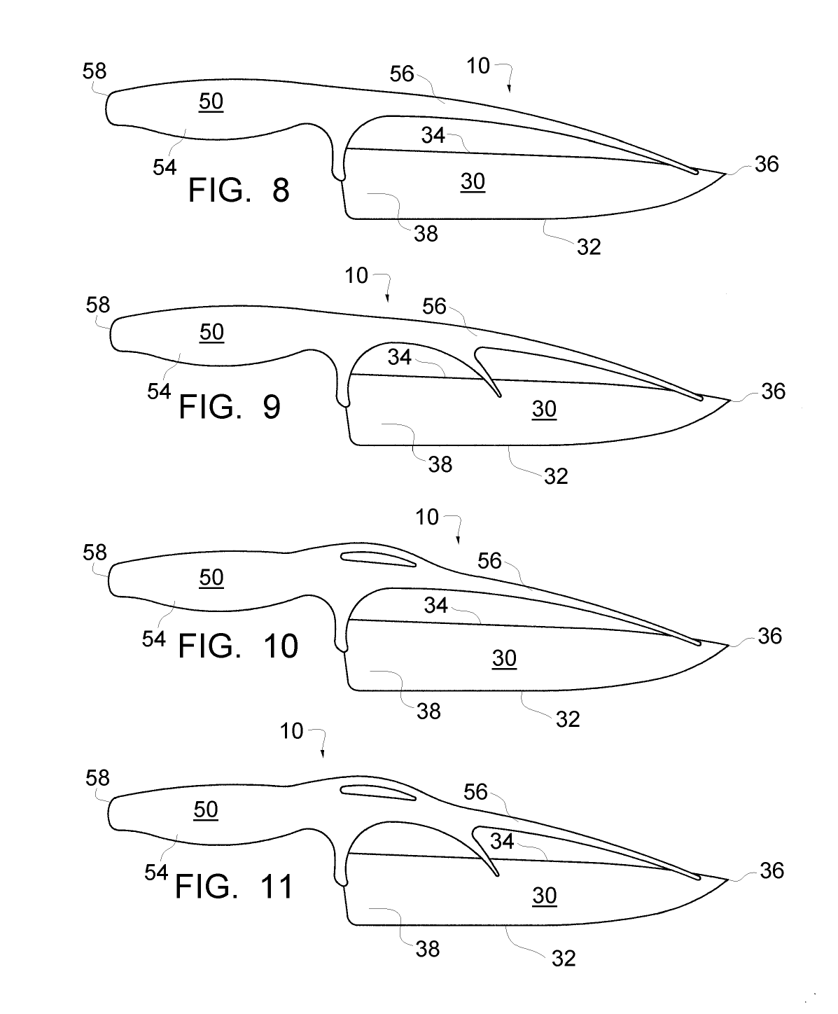

FIGS. 8 to 12 show alternative embodiments of the present invention to help illustrate the wide variety of design configuration that are available within the scope of the present invention. One common feature in these designs is the placement of the grip portion 54 raised significantly from the cutting edge 32, even behind the spine 34, known as an offset handle. This offset handle design gives a leverage advantage to the user and the ability to use a greater length of the cutting edge 34 in certain applications. This offset handle construction uses a vertical tang 40 on the knife blade 30 and together with the support arm 56 gives a distinctive look to this family of knifes 10.

The embodiments of FIGS. 9, 11 and 12 show the use of multiple coupling points between the spine support 56 and the knife blade 30 to allow for the transfer of force to several locations along the knife blade 30. The provision of a second support arm or connection point along the spine support 56 allows forces to be distributed as desired along the knife blade. Additional connection points can be provided if desired. It is believed to be sufficient and preferable, where multiple spine support connection points are utilized, to have one across from the tip 32a of the blade 30 and one across from the middle cutting edge 32b.

The embodiments of FIGS. 10 and 11 illustrate that the spine support 56 can include a second arcuate member thereon to create a double spring effect for the spine support. This modification illustrates that the shape of the spine support 56 can be varied to accomplish the desired flexing characteristics. Additionally an internal support 61, shown in FIG. 19, can be added for the needed strength to the spine support 56 and to allow for the desired flexing characteristics. The internal support 61 of the spine support 56 can be formed of any desired material, but a metal member is deemed to most easily provide the desired strength. FIG. 19 further illustrates that the spine support 56 may have a diverging cross section in a direction extending away from the knife blade 30, which will serve to help separate materials being cut by the knife 10. The cross section should be larger than the spine 34.

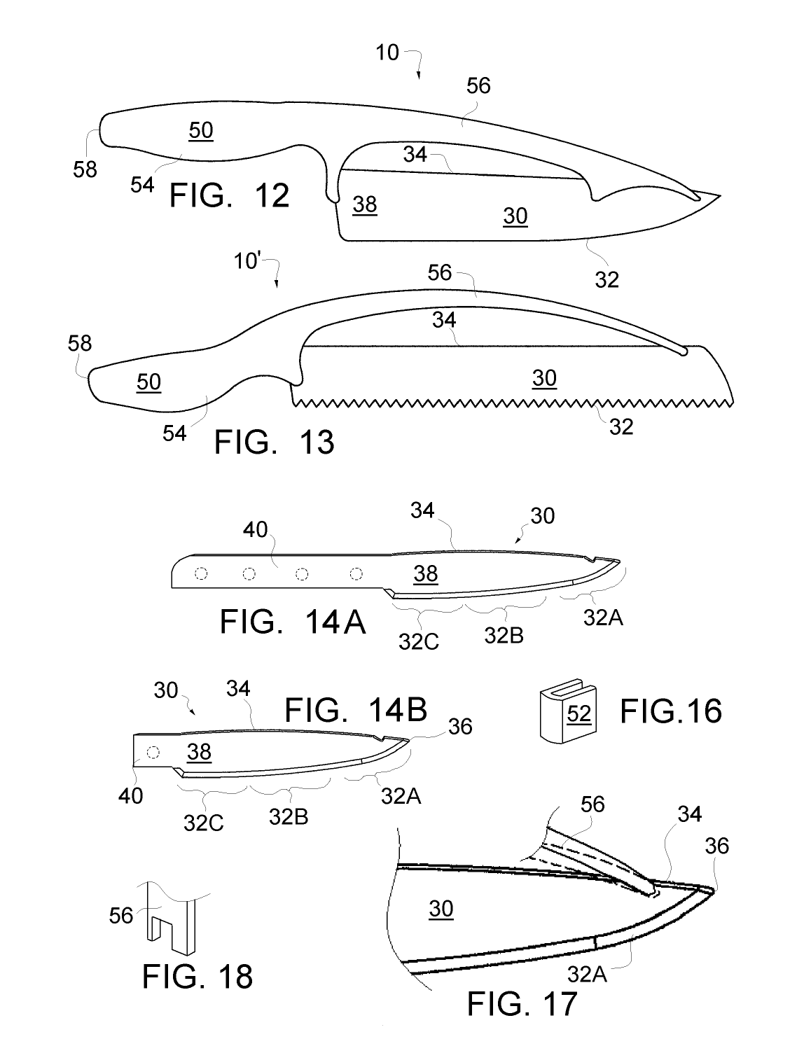

FIG. 13 illustrates cutting implement 10′ in accordance with the present invention. The implement 10′ is a hand saw and has a serrated cutting edge along the entire length of the cutting edge 32, and is not described as a knife as the blade 30 does not have a point in which the spine 34 and the cutting edge 32 meet. The remaining aspects of the implement 10′ are as described above.

The above descriptions illustrate that the cutting implements, such as knifes 10, of the present invention can be formed in a wide variety of configurations. The present invention is particularly well suited for forming a set of culinary knifes 10 such as shown in FIG. 1. A set of knifes 10 can include a series of knife blades 30 for distinct purposes (e.g. a paring knife blade, a bread knife and a chef's knife) having a common family of handles 50. A set of culinary knifes 10 can include a series of identical knife blades 30 such as a steak knife set. Further set of culinary knifes 10 can include a series of identical knife blades 30 and several distinct knife blades 30.

In the formation of knife sets having distinct blades 30 the grip portions 54 and butt ends 58 of the handles 50 will be common across the set. The tang engagement and the spine support 56 will be configured for the particular blade 30. It can greatly decrease manufacturing costs for molded handles 50 if the grip portions 54 and butt ends 58 are formed in a common mold and the spine support 56 and tang engagement ends of the handle 50 were formed by separate inserts added to the mold.

Another aspect of the present invention is a mounting block 20 for selectively receiving the knives 10 of a knife set. The details of the mounting block 20 are shown in FIGS. 20-23. The mounting block 20 has a body 60 having knife receiving grooves 62 on an upper surface thereof, wherein it is preferred if the grooves and the top surface of the body 60 match the curve of the cutting edge 32 of the knife blade 30. The grooves 62 on the mounting block body 60 are configured to extend from a point 36 to a bolster end 38 of each associated knife 10 and fully support the knife 10 therein in a free standing position. The grooves 62 can be relatively shallow and provide the needed lateral support to the blades 30. Grooves 62 of a little less than ¼″ have been found to be sufficient in depth. Beneath each groove 62 is a plurality magnetic members 64 that can selectively engage the knife blades 30 to assist in guiding the blades 30 into the grooves 62, and assist in holding them in this position. The main purpose of the magnetic members 64 is the guiding of the knife blades 30 into the grooves 62 as the user moves the knive blade 30 over the top surface of the body 60. As the user is close to the desired position the blade 30 will be drawn into the proper engaged position by the magnetic members 64. The magnetic members 64 allow the shallow grooves 62 on the upper surface of the body 62 to be practical as a knife mounting block 20 and give wide latitude to the designers of the block 20. The block 20 can be made out of any convenient material such as wood, metal or plastic. The number of grooves 62 can be varied as desired depending on the number of knives in the set. Further, the block 20 may be used with conventional knife holding slots (not shown) extending in the top and/or side surface together with the grooves 62 as shown. A conventional knife holding slot will accept the tip 36 of the blade 30 and the knife blade (and spine support 56 for knifes 10) will be axially slid into the receiving slot with the handle 50 sticking out of the block 20. For example, a complete knife set may have a series of similar (steak) knives 10 mounted in conventional slots within the block 20 and the specialty culinary knives 10 of the set (e.g. butcher, paring, bread, etc) mounted within associated grooves 62. The shallow grooves 62 and associated magnetic members 64 represent the novel features of the block 20 and these are the aspects that are illustrated.

The mounting block 20 may be referenced as a stand system consisting of body 60 with open grooves 62 and magnetic members 64 for the positioning of knives 10 into the block 20. The Magnetic members 64 guide knife blades 30 into the open grooves 62 for stable holding position. The mounting block can be applied to horizontal, side, and vertical base positions.

The preferred embodiments described above are illustrative of the present invention and not restrictive hereof. It will be obvious that various changes may be made to the present invention without departing from the spirit and scope of the invention. The precise scope of the present invention is defined by the appended claims and equivalents thereto.

What is claimed is:

1. A knife comprising:
A knife blade defining a knife plane having a cutting edge on one side and a spine an opposed side of the knife blade, wherein the cutting edge and the spine meet at a point of the knife blade at a distal end of the knife blade, the knife blade including a bolster at an end of the knife blade opposed from the point and a tang adjacent the bolster; and
A handle attached to the tang of the knife blade, the handle includes a body portion, the handle includes a spine support extending along a portion of the spine of the knife blade and coupled to the knife blade at a position spaced from the point, and wherein the spine support is spaced from the spine for at least a portion of the spine.

2. The knife of claim 1 wherein the coupling between the spine support and the knife blade allows relative motion there between.

3. The knife of claim 2 wherein the spine support is a curved member.

4. The knife of claim 3 wherein the spine support has a diverging cross section in a direction extending away from the knife blade.

5. The knife of claim 4 wherein the spine support is coupled to the knife blade at a location laterally aligned with the tip of the cutting edge of the knife blade and wherein the coupling between the spine support and the knife blade allows a pivoting motion there between.

6. The knife of claim 1 wherein the spine support includes a metal reinforcement member therein and further including a resilient buffer member between the knife blade and the handle.

7. A knife comprising:
A knife blade defining a knife plane having a cutting edge on one side and a spine an opposed side of the knife blade, wherein the cutting edge and the spine meet at a point of the knife blade at a distal end of the knife blade, the knife blade including a bolster at an end of the knife blade opposed from the point and a tang adjacent the bolster; and
A handle attached to the tang of the knife blade, further including a resilient buffer member between the tang of the knife blade and the handle, wherein the handle includes a body portion and the handle includes a spine support extending along a portion of the spine of the knife blade and coupled to the knife blade, and wherein the spine support is spaced from the spine for at least a portion of the spine.

8. The knife of claim 7 wherein the coupling between the spine support and the knife blade allows relative pivoting motion there between.

9. A culinary knife set comprising a plurality of knives, each knife of the knife set including a knife blade defining a knife plane having a cutting edge on one side and a spine an opposed side of the knife blade, wherein the cutting edge and the spine meet at a point of the knife blade at a distal end of the knife blade, the knife blade including a bolster at an end of the knife blade opposed from the point and a tang adjacent the bolster, and a handle attached to the tang of the knife blade, the handle includes a body portion, the handle includes a spine support extending along a portion of the spine of the knife blade and coupled to the knife blade at a position spaced from the point, and wherein the spine support is spaced from the spine for at least a portion of the spine.

10. The culinary knife set of claim 9 further including a mounting block selectively receiving the knives of the knife set.

11. The culinary knife set of claim 10 wherein the mounting block includes a body having knife receiving grooves on an upper surface thereof.

12. The culinary knife set of claim 10 wherein the grooves on the mounting block body are configured to extend from the point to the bolster end of each associated knife.

13. The culinary knife set of claim 10 wherein the grooves on the mounting block body are less than ¼″.

14. The culinary knife set of claim 11 wherein the knife blades are steel and further including magnetic members selectively engaging the knife blades within the grooves.

15. The culinary knife set of claim 9 wherein the coupling between the spine support and the knife blade for each knife allows relative motion there between.

16. The culinary knife set of claim 15 wherein the spine support for each knife is a curved member and wherein the spine support of each knife has a diverging cross section in a direction extending away from the knife blade.

17. A cutting implement comprising:
A blade defining a blade plane having a cutting edge on one side and a spine an opposed side of the blade, the blade including a bolster at an end of the blade a tang adjacent the bolster; and
A handle attached to the tang of the blade, the handle includes a body portion, the handle includes a spine support extending along a portion of the spine of the blade and coupled to the blade at a position spaced from the tang, wherein the spine support is spaced from the spine for at least a portion of the spine, wherein the coupling between the spine support and the blade allows a pivoting motion there between.

18. The cutting implement of claim 17 wherein the spine support is a curved member.

19. The cutting implement of claim 17 wherein the cutting edge includes a serrated portion.

20. A mounting block for selectively receiving the knives of a knife set, the mounting block comprising:
a body having knife receiving grooves on an upper surface thereof, wherein the grooves on the mounting block body are configured to extend from a point to a bolster end of each associated knife; and
a plurality magnetic members selectively engaging the knife blades within the grooves.
